(19) United States
(12) Patent Application Publication
(10) Pub. No.: US 2025/0206957 A1
(43) Pub. Date: Jun. 26, 2025

(54) ANTI-FOGGING COMPOSITION, TRANSLUCENT MEMBER AND METHOD FOR PRODUCING THE SAME, AND OPTICAL UNIT AND METHOD FOR PRODUCING THE SAME

(71) Applicant: STANLEY ELECTRIC CO., LTD., Tokyo (JP)

(72) Inventors: Koji HORIBA, Tokyo (JP); Hasumi OKAMOTO, Tokyo (JP)

(21) Appl. No.: 18/982,846

(22) Filed: Dec. 16, 2024

(30) Foreign Application Priority Data
Dec. 22, 2023 (JP) 2023-216769

(51) Int. Cl. C09D 4/00; B05D 3/06; B05D 5/08; C09D 7/63

(52) U.S. Cl. CPC C09D 4/00; B05D 3/067; B05D 5/08; C09D 7/63

(57) ABSTRACT

An exemplary aspect of the presently disclosed subject matter is to provide an anti-fogging composition having excellent anti-fogging properties, a translucent member and a method for producing the same, and an optical unit and a method for producing the same. The active energy ray-curable anti-fogging composition includes a radically reactive material including a hydrophilic group, a reactive betaine compound, and N-vinyl-2-pyrrolidone, and has a viscosity of 3 mPa·s to 70 mPa·s.

### BACKGROUND

### 1. Field

The presently disclosed subject matter relates to an anti-fogging composition, a translucent member and a method for producing the same, and an optical unit and a method for producing the same.

### 2. Description of the Related Art

Transparent synthetic resins such as a polycarbonate resin (PC), a polymethyl methacrylate resin (PMMA) are excellent in transparency, moldability, and mechanical properties, and are therefore used in many fields such as a cover of a lamp of an automobile, a motorcycle, or the like, a lens of glasses, a cover of an optical sensor, various liquid crystal panels. However, in a case where a surface of a member such as a synthetic resin has a surface temperature equal to or lower than the dew point temperature, moisture in the atmosphere condenses into fine water droplets and fogging occurs. As a result, it reduces light transmission, causing poor visibility and malfunctions in sensors and the like. In order to prevent such a problem, a composition is applied to a surface of a member, and a hydrophilic cured film obtained by curing the composition is formed on the surface of the member, thereby securing transparency.

For example, Patent Literature 1 discloses an active energy ray-curable anti-fogging composition containing a hydroxyl group-containing (meth)acrylate compound (A), a nonionic anti-fogging agent (B), an aqueous unsaturated group-containing mixing promoter (C), and a hydrophilic resin (D).

### CITATION LIST

### Patent Literature

[Patent Literature 1] Japanese Patent No. 7102957

### SUMMARY

### [Exemplary Problems to be Solved by the Presently Disclosed Subject Matter]

However, even in a case where such an active energy ray-curable anti-fogging composition is used, there is a concern that the anti-fogging properties are insufficient and fogging of a member occurs.

The presently disclosed subject matter has been made in view of the above-described points, and an exemplary aspect of the presently disclosed subject matter is to provide an anti-fogging composition having more excellent anti-fogging properties, a translucent member and a method for producing the same, and an optical unit and a method for producing the same.

### [Exemplary Means for Solving the Problem]

The anti-fogging composition of the presently disclosed subject matter can include:
a radically reactive material including a hydrophilic group, a reactive betaine compound, and N-vinyl-2-pyrrolidone.

### BRIEF DESCRIPTION OF THE DRAWINGS

FIG. 1 is a conceptual view illustrating an anti-fogging composition and a translucent member of the presently disclosed subject matter.

FIG. 2 is a conceptual view illustrating an optical unit of the presently disclosed subject matter.

FIG. 3 is a view illustrating a step of producing a translucent member having a cured film obtained by curing the anti-fogging composition of the presently disclosed subject matter.

FIG. 4 is a table summarizing the compositions in Examples and Comparative Examples of the anti-fogging composition of the presently disclosed subject matter.

FIG. 5 is a table summarizing the comparison results between Examples and Comparative Examples of the anti-fogging composition of the presently disclosed subject matter.

### DESCRIPTION OF EXEMPLARY EMBODIMENTS

Embodiments of the presently disclosed subject matter will be described. An anti-fogging composition 10 of the presently disclosed subject matter is an active energy-curable anti-fogging composition including a radically reactive material, a reactive betaine compound, N-vinyl-2-pyrrolidone, and an initiator.

The anti-fogging composition 10 is a solvent-free type. Here, the term “solvent-free type” indicates that the anti-fogging composition 10 does not contain or substantially does not contain a non-reactive volatile organic solvent. The phrase “substantially does not contain a non-reactive volatile organic solvent” indicates that a total value of components detected by gas chromatography analysis of the anti-fogging composition 10 at 200° C. in a structure not including a vinyl group or an acryloyl group is less than 1% by mass.

Since the anti-fogging composition 10 is the solvent-free type, in a case where the anti-fogging composition 10 is cured, most of the anti-fogging composition 10 forms a cured film as an active ingredient. Therefore, it is possible to reduce a total amount of the anti-fogging composition 10 required in a case of applying the anti-fogging composition 10 onto a surface of a translucent member 20.

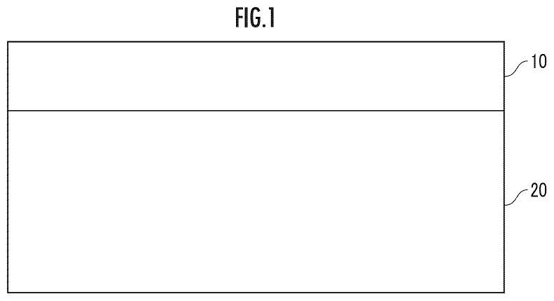

The radically reactive material contains a hydrophilic group. As illustrated in FIG. 1, in a case where the anti-fogging composition 10 is applied onto a surface of the hydrophobic translucent member 20 (for example, a polycarbonate resin), at least a part of the hydrophilic group is disposed in a surface layer of the anti-fogging composition 10. Then, by curing the anti-fogging composition 10 through a radical reaction, a cured film having a hydrophilic group can be formed on the surface of the translucent member 20.

Since the hydrophilic group is disposed on the surface of the anti-fogging composition 10, the surface of the anti-fogging composition 10 has a hydrophilic function. Therefore, it is possible to reduce the contact angle of the surface of the anti-fogging composition 10 with water. As a result, moisture is diffused on the surface of the anti-fogging composition 10 to form a water film, and the anti-fogging properties of the translucent member 20 can be secured.

The radically reactive material is a radically reactive material consisting of a resin component such as a monomer or oligomer. By configuring the anti-fogging composition 10 to contain the radically reactive material, the viscosity of the anti-fogging composition 10 can be adjusted. Therefore, the anti-fogging composition 10 can be used for painting without being diluted with an organic solvent. As a result, in the step of curing the anti-fogging composition 10 on the surface of the translucent member 20, a thermal drying step is not required and the power consumption during the production can be reduced.

The content of the radically reactive material is preferably 70% by mass or more and 90% by mass or less with respect to the total amount of the active energy ray-curable anti-fogging composition 10. By setting the content of the radically reactive material having a low viscosity to 70% by mass or more with respect to the total amount of the anti-fogging composition 10, the anti-fogging composition 10 can be adjusted to a viscosity suitable for spray coating without being diluted with an organic solvent. The viscosity suitable for spray coating is, for example, 3 to 70 mPa·s/25° C..

In addition, in a case where the content of the radically reactive material is less than 70% by mass with respect to the total amount of the anti-fogging composition 10, a sufficient hydrophilic function cannot be secured on the surface of the cured film and the fogging of the translucent member cannot be prevented. On the other hand, in a case where the content of the radically reactive material is more than 90% by mass, sufficient adhesiveness to the translucent member 20 which is hydrophobic cannot be secured.

As the radically reactive material, PEG200 diacrylate, PEG600 diacrylate, pentaerythritol triacrylate, 2-hydroxy-3-acryloyloxypropyl methacrylate, 1,3-diallyloxy-2-propanol, polyethylene glycol diacrylate, triethylene glycol diacrylate, polypropylene glycol diacrylate, polytetramethylene glycol diacrylate, urethane acrylate, or the like can be used. In addition, these radically reactive materials may be used alone or in combination of any two or more kinds thereof.

The betaine compound refers to a compound having a positive charge and a negative charge at non-adjacent positions in the same molecule, in which a hydrogen atom that can be dissociated is not bonded to an atom having a positive charge, and the entire molecule does not have a charge. Among these, the reactive betaine compound refers to a compound which includes any of a (meth)acryloyl group or a (meth)acrylamide group as a reactive group, and includes a carboxybetaine structure, a phosphobetaine structure, or a sulfobetaine structure as a betaine structure.

Since the betaine structure exhibits high hydrophilicity, the hydrophilicity of the anti-fogging composition 10 can be further improved by configuring the anti-fogging composition 10 to contain a reactive betaine. By improving the hydrophilicity of the anti-fogging composition 10, in a case where water droplets are attached onto a cured film obtained by curing the anti-fogging composition 10, the water droplets are likely to wet and spread on the cured film. Therefore, the anti-fogging effect of the cured film can be improved and water drip marks caused by the water droplets can be reduced.

The content of the reactive betaine compound is preferably 0.1% by mass or more and 10% by mass or less with respect to the total amount of the anti-fogging composition 10. In a case where the content of the reactive betaine compound is less than 0.1% by mass, the hydrophilicity of the anti-fogging composition 10 cannot be further improved. On the other hand, in a case where the content of the reactive betaine compound is more than 10% by mass, turbidity of the cured film occurs due to a decrease in solubility.

As the reactive betaine compound, for example, compounds represented by General Formulae (I) to (XI) can be used. In detail, for example, as a sulfobetaine monomer, a [3-(methacryloylamino)propyl]dimethyl(3-sulfopropyl)ammonium hydroxide inner salt, 3-[[2-(methacryloyloxy)ethyl]-dimethylammonio]propane-1-sulfonate, [4-[[2-(methacryloyloxy)ethyl]dimethylammonio]butane-1-sulfonate, 3-[[2-(acryloyloxy)ethyl]-dimethylammonio]propane-1-sulfonate, bis[2-(methacryloyloxy)ethyl](methyl)ammonio]propane-1-sulfonate, 4-[(3-methacrylamidopropyl)dimethylammonio]butane-1-sulfonate, 3-[(3-acrylamidopropyl)-dimethylammonio]propane-1-sulfonate, or the like, shown in General Formulae (I) to (VII), can be used.

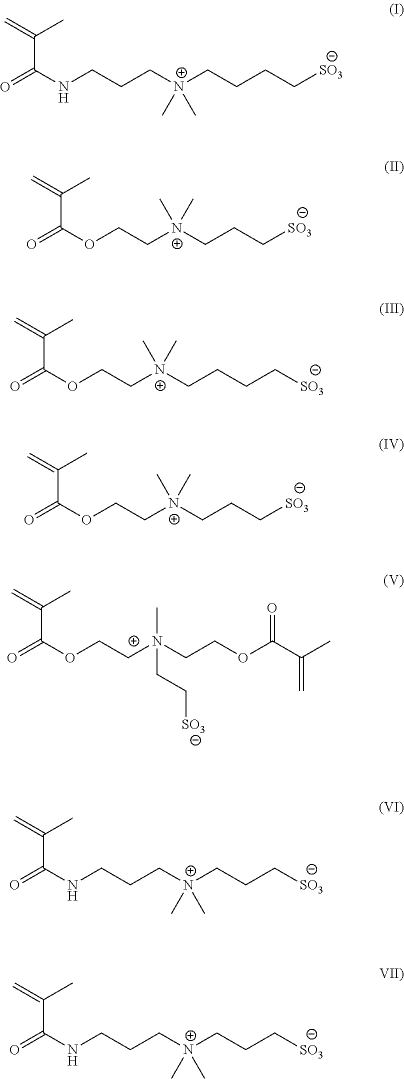

In addition, for example, as a carboxybetaine-type monomer, 2-[[2 (methacryloyloxy)ethyl]-dimethylammonio]acetate, 3-[(3-acrylamidopropyl)-dimethylammonio]propionate, 3-[(3-acrylamidopropyl)dimethylammonio]propanoate, or the like, represented by General Formulae (VIII) to (X), can be used.

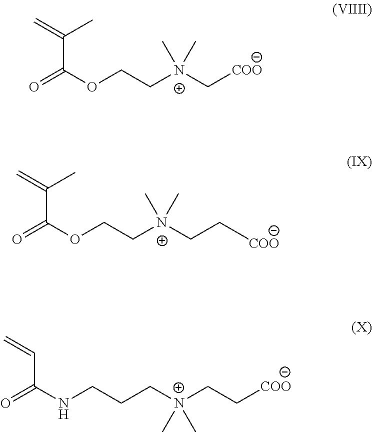

In addition, for example, as a phosphobetaine type monomer, 2-methacryloyloxyethylphosphorylchloride or the like, represented by General Formula (XI), can be used.

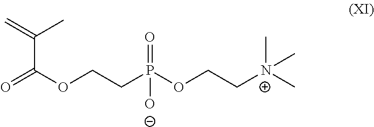

N-vinyl-2-pyrrolidone is represented by General Formula (XII).

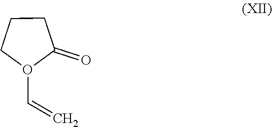

By configuring the anti-fogging composition 10 to contain N-vinyl-2-pyrrolidone having high solubility, the content of the reactive betaine compound in the anti-fogging composition 10 can be increased. The content ratio of the reactive betaine compound to N-vinyl-2-pyrrolidone is preferably 1:5 to 1:3.

The content of N-vinyl-2-pyrrolidone is preferably 1% by mass or more and 15% by mass or less with respect to the total amount of the anti-fogging composition 10. In a case where the content of N-vinyl-2-pyrrolidone is less than 1% by mass, the solubility of the reactive betaine compound is low, causing turbidity to occur in the cured film. On the other hand, in a case where the content of N-vinyl-2-pyrrolidone is more than 15% by mass, polyvinylpyrrolidone is separated, causing the anti-fogging properties of the cured film to be decreased.

The initiator is a radical generator that generates a highly active radical upon irradiation with ultraviolet rays. This radical species reacts with a resin component such as a monomer and/or oligomer after decomposition and the like. A reaction product therefrom further reacts with another resin component, causing the reaction to proceed in a chain manner. Then, the crosslinking reaction proceeds, the molecular weight increases, and the radically reactive material is cured to form a cured film.

The content of the initiator is preferably 0.1% by mass or more and 8% by mass or less with respect to the total amount of the anti-fogging composition 10. In a case where the content of the initiator is less than 0.1% by mass, the anti-fogging composition is insufficiently cured and curing failure occurs. On the other hand, in a case where the content of the initiator is more than 8% by mass, the molecular weight does not increase and the strength of the cured film is insufficient.

As the initiator, for example, known compounds, such as ketone-based compounds such as 1-hydroxycyclohexyl phenyl ketone, 2-hydroxy-4′-(2-hydroxyethoxy)-2-methylpropiophenone, benzophenone, benzoin methyl ether, benzoin propyl ether, diethoxyacetophenone, azo-based compounds such as 2,2′-azobisisobutyronitrile, azobis-2-methylbutyronitrile, azobisdivaleronitrile, organic peroxide-based compounds such as t-butyl peroxyisobutyrate, t-butyl peroxy-2-ethylhexanoate, t-amyl peroxy 3,5,5-trimethylhexanoate, t-butyl peroxyisopropyl carbonate, 2,2-bis(4,4-di-t-butylperoxycyclohexyl) propane, di-t-butyl peroxide, di-t-amyl peroxide, or acylphosphine-based compounds such as 2,6-dimethylbenzoyldiphenylphosphine oxide, 2,4,6-trimethylbenzoyldiphenylphosphine oxide can be used. Among these, radical cleavage-type initiators such as 1-hydroxycyclohexyl phenyl ketone, 2,4,6-trimethylbenzoyldiphenylphosphine oxide are preferable. In addition, these initiators may be used alone or in combination of two or more kinds thereof.

The anti-fogging composition 10 may contain various additives such as an antibacterial agent, an anti-cavity agent, an antifoaming agent, an antioxidant, an antistatic agent, a polymerization inhibitor in addition to the initiator.

As the antibacterial agent, for example, captan, carbendazim, quinomethionate, chlorothalonil, clozolinate, cyprodinil, epoxiconazole, famoxadone, fenarimol, fenbuconazole, fenflumorph, fenpiclonil, azoxystrobin, benalaxyl, benomyl, bitertanol, fluazinam, fludioxonil, fluoroimide, fluquinconazole, furosulfamide, flutolanil, folpet, hexachlorobenzene, hexaconazole, iproconazole, iprodione, kresoxim-methyl, mancozeb, maneb, mepanipyrim, mepronil, metconazole, metiram, phthalide, procymidone, propineb, quintozene, technazene, cyflufenamid, thiophanate-methyl, thiram, tolclofos-methyl, triflumizole, triadimefon, triadimenol, triazoxide, triforine can be used. In addition, as the inorganic antibacterial agent, for example, silver, copper, zinc, tin, lead, gold can also be used. Furthermore, as the antibacterial agent of the composition, for example, polyhexamethylene biguanide, hydrocholoride, benzethonium chloride, alkyl polyaminoethyl glycine, benzisothiazoline can be used.

As the anti-cavity agent, for example, sodium dehydroacetate, sodium benzoate, sodium pyridinethione-1-oxide, ethyl p-hydroxybenzoate, 1,2-benzisothiazolin-3-one and a salt thereof can be used.

As the antifoaming agent, for example, fatty acid salts, liquid fatty oil sulfuric acid esters, higher alcohol sulfates, aliphatic alcohol phosphoric acid esters, fatty acid amide sulfonates, sulfonates of a dibasic fatty acid ester, alkylallyl sulfates, polyoxyethylene alkyl ethers, polyoxyethylene alkylphenol ethers, polyoxyethylene alkyl esters, sorbitan alkyl esters, polyoxyethylene sorbitan alkyl esters, acrylic polymers, vinyl polymers, organopolysiloxanes can be used.

As the antioxidant, for example, a phenol-based antioxidant, a phosphorus-based antioxidant, a sulfur-based antioxidant can be used. As the phenol-based antioxidant, for example, 2,6-di-tert-butyl-p-cresol, stearyl β-(3′,5′-di-tert-butyl-4-hydroxyphenyl) propionate, 1,3,5-trimethyl-2,4,6-tris(3′,5′-di-tert-butyl-4-hydroxybenzyl)benzene can be used. As the phosphorus-based antioxidant, for example, tris(2,4-di-tert-butylphenyl) phosphite, diphenylmono(2-ethylhexyl)phosphite, 2,2′-methylenebis(4,6-di-tert-butylphenyl)-2-ethylhexylphosphite, distearyl pentaerythritol diphosphite, tri (mnononylphenyl)phosphite can be used. As the sulfur-based antioxidant, for example, dilauryl-3,3′-thiodipropionate, pentaerythritol tetrakis(3-lauryl thiopropionate) can be used.

As the antistatic agent, for example, various cationic antistatic agents having a cationic group, such as a primary to tertiary amino group, a quaternary ammonium salt, a pyridinium salt, an anionic antistatic agent having an anionic group, such as a sulfonic acid salt group, a sulfuric acid ester salt group, a phosphoric acid ester salt group, a phosphonic acid salt group, an amphoteric antistatic agent such as an amino acid-based antistatic agent, an amino sulfuric acid ester-based antistatic agent, a nonionic antistatic agent such as an amino alcohol-based antistatic agent, a glycerin-based antistatic agent, a polyethylene glycol-based antistatic agent, a polymer type antistatic agent obtained by increasing the molecular weight of the above-described antistatic agent can be used.

A polymerization inhibitor may be added so that a double bond does not react. As the polymerization inhibitor, for example, phenol or naphthol derivatives such as hydroquinone (HQ), hydroquinone monomethyl ether (MEHQ), 2,6-di-t-butyl-4-methylphenol (BHT), t-butylcatechol (TBC), 4-methoxy-1-naphthol, phenothiazine derivatives, nitrosamine salts can be used.

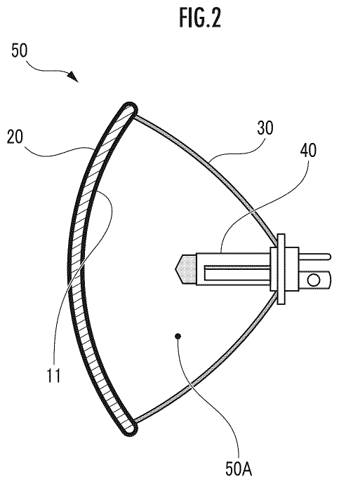

FIG. 2 illustrates an optical unit 50 having a translucent member 20, having a part of the surface coated with a cured film 11 obtained by curing the anti-fogging composition 10. The optical unit 50 includes a translucent member 20, a housing 30, and an optical instrument 40. The optical instrument 40 is disposed in an inner space 50A defined by the translucent member 20 and the housing 30.

In the present embodiment, the optical unit 50 is a headlight unit for a vehicle. Furthermore, the optical unit 50 may be used for, for example, a vehicle backlight unit, a vehicle turn signal light unit, an optical sensor unit, a camera, a streetlight by appropriately modifying the translucent member 20 and the optical instrument 40 included in the optical unit 50.

In the present embodiment, the translucent member 20 is a polycarbonate resin (PC). Furthermore, depending on a use of the optical unit 50, for example, a hydrophobic synthetic resin such as a polymethyl methacrylate resin (PMMA), or a hydrophobic material such as glass may be used as the translucent member 20.

In the present embodiment, the optical instrument 40 is an LED light source. Furthermore, depending on the use of the optical unit 50, the optical instrument 40 may be an illumination device such as a fluorescent lamp or an incandescent bulb, a light source of an optical sensor that emits visible light, infrared rays, ultraviolet rays, or electromagnetic waves, a light receiving device that detects visible light, infrared rays, ultraviolet rays, or electromagnetic waves, or the like. In addition, the optical instrument 40 may be configured with an optical unit consisting of a light source of the optical sensor and a light receiving device that detects reflected light of light emitted from the light source of the optical sensor.

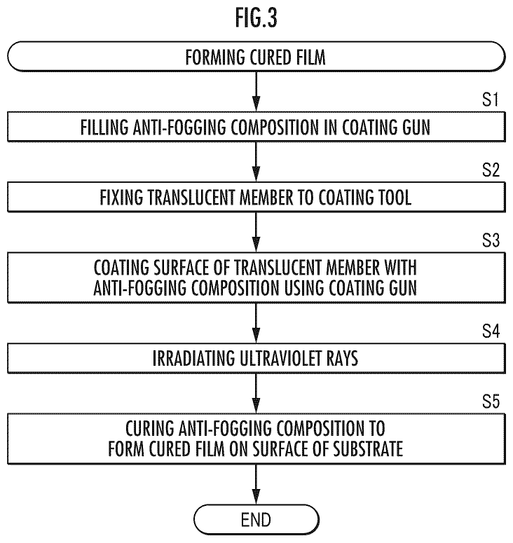

A method for producing the translucent member 20, having a part of the surface coated with a cured film 11 obtained by curing the anti-fogging composition 10, will be described with reference to FIG. 3. First, the anti-fogging composition 10 was filled in a coating gun (S1). Thereafter, the translucent member 20 to be coated was fixed to a coating tool (S2). The surface of the translucent member 20 was coated with the anti-fogging composition 10 using the coating gun to provide a uniform film thickness of less than 10 μm (S3). The anti-fogging composition 10 was irradiated with ultraviolet rays (active energy) (S4). The anti-fogging composition 10 was cured on the surface of the translucent member 20 to form a cured film 11 (S5). As described above, the translucent member 20, having a part of the surface coated with the cured film 11 obtained by curing the anti-fogging composition 10, can be produced.

In addition, the optical unit 50 can be produced by forming the inner space 50A defined by the translucent member 20 and the housing 30 with a direction in which the cured film 11 is formed in the translucent member 20 as the inner side, and disposing the optical instrument 40 in the inner space 50A.

Furthermore, in a case where the anti-fogging composition 10 is applied onto the surface of the translucent member 20, the anti-fogging composition 10 may be applied onto a part of the surface of the translucent member 20 or the entire surface of the translucent member 20. In addition, a method for applying the anti-fogging composition 10 is not limited to a method using a coating gun, and a coating method using an ink jet or a dispenser can also be adopted.

### Modified Example 1

Modified Example 1 of the anti-fogging composition 10 of the present embodiment will be described. Furthermore, it is noted that the same configuration as that of the anti-fogging composition 10 of the embodiment of the presently disclosed subject matter will not be described as appropriate. Modified Example 1 of the anti-fogging composition 10 is an active energy-curable anti-fogging composition including a radically reactive material, a reactive betaine compound, N-vinyl-2-pyrrolidone, an initiator, and a thiol material. That is, the present embodiment is different from the embodiment in that a thiol material is contained.

The thiol material is a compound including a polyfunctional thiol group. That is, the compound is a compound including a bifunctional or higher functional thiol group. By configuring the anti-fogging composition 10 to contain the thiol material, oxygen inhibition can be suppressed by a thiol-ene reaction.

The reaction mechanism of the thiol-ene reaction is shown below. First, the initiator is irradiated with ultraviolet rays to cause cleavage or energy transfer (an initiation reaction). Thereafter, the initiator extracts electrons from the thiol material to generate a thiyl radical. The thiyl radical attacks a double bond of a monomer of the radically reactive material to form a thioether crosslink and a radically reactive material having a radical. This further extracts hydrogen from the thiol material to generate a thiyl radical. Then, the generated thiyl radical attacks a double bond of a monomer of another radically reactive material (a growth reaction). In this way, the reaction proceeds in a chain manner and the anti-fogging composition 10 can be efficiently cured.

Initiation reaction Initiator→1.

Growth reaction I·+R—S—H—→I—H+R—S.

R—S·+CH₂═CH—X→R—S—CH₂—CH—X

R—S—CH₂—CH—X+R—S—H→R—S—CH₂—CH₂—X+R—S.

By configuring the anti-fogging composition 10 to contain the thiol material, curing can be promoted by a dark reaction even in the atmosphere (in an oxygen atmosphere). The reaction mechanism in an oxygen atmosphere is shown below. First, oxygen and a monomer react with each other to generate a peroxyl radical. Thereafter, the peroxyl radical extracts hydrogen from the thiol to generate a thiyl radical. Then, the growth reaction proceeds via the thiyl radical. Therefore, the anti-fogging composition can be cured even in an oxygen atmosphere.

M·+O₂→M—O—O—

M—O—O—+R—S—H→M—O—O—M+R—S.

By configuring the anti-fogging composition 10 to contain the thiol material, a thioether crosslinking structure is formed and the flexibility of the cured film can be improved. Therefore, the occurrence of cracks in a low-temperature environment can be suppressed, and the durability can be further improved. Here, a reason why the flexibility of the cured film can be increased is that the sulfur atom can move by rotation and the like in the thioether crosslinking structure.

By configuring the anti-fogging composition 10 to contain the thiol material, curing shrinkage can be suppressed. The curing shrinkage occurs by polymerizing the double bonds of a radically reactive material by radical polymerization to change the radically reactive material into a polymerized substance connected by a single bond, and shortening a molecular bond distance. However, by containing the thiol material, the thiol material reacts with the double bond of the radically reactive material to form a thioether crosslink, whereby the shortening of the molecular bond distance can be suppressed. Therefore, the curing shrinkage is suppressed and the occurrence of defects such as cracks, warping of the cured film can be suppressed.

The content of the thiol material is preferably 2% by mass or more and 10% by mass or less with respect to the total amount of the anti-fogging composition 10.

### EXAMPLES

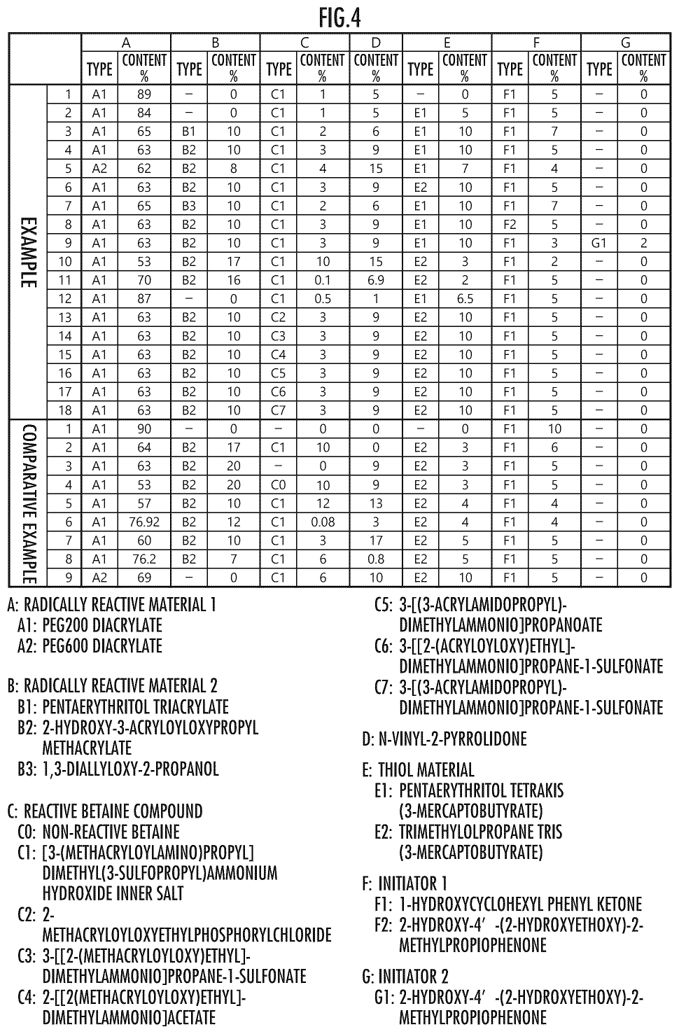

Hereinafter, the presently disclosed subject matter will be described in more detail with reference to Examples and Comparative Examples. Furthermore, the presently disclosed subject matter is not limited to these Examples. The compositions of Examples and Comparative Examples of the anti-fogging composition of the presently disclosed subject matter are described in FIG. 4.

### Example 1

89 parts by mass of PEG200 diacrylate (product name: PEG200DA, manufactured by Daicel-Allnex Ltd.) as a radically reactive material, 1 part by mass of a [3-(methacryloylamino) propyl]dimethyl (3-sulfopropyl) ammonium hydroxide inner salt (product name: FOM-03010, manufactured by FUJIFILM Wako Pure Chemical Corporation) as a reactive betaine compound, and 5 parts by mass of N-vinyl-2-pyrrolidone (product code: 224-01282, manufactured by FUJIFILM Wako Pure Chemical Corporation) were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 1.

### Example 2

84 parts by mass of PEG 200 diacrylate (product name: PEG200DA, manufactured by Daicel-Allnex Ltd.) as a radically reactive material, 1 part by mass of a [3-(methacryloylamino) propyl]dimethyl (3-sulfopropyl) ammonium hydroxide inner salt (product name: FOM-03010, manufactured by FUJIFILM Wako Pure Chemical Corporation) as a reactive betaine compound, 5 parts by mass of N-vinyl-2-pyrrolidone (product code: 224-01282, manufactured by FUJIFILM Wako Pure Chemical Corporation), and 5 parts by mass of pentaerythritol tetrakis(3-mercaptobutyrate) (product name: KarenzMT® PE1, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 2.

### Example 3

65 parts by mass of PEG200 diacrylate (product name: PEG200DA, manufactured by Daicel-Allnex Ltd.) and 10 parts by mass of pentaerythritol triacrylate (product name: Light Acrylate PE-3A, manufactured by Kyoeisha Chemical Co., Ltd.) as a radically reactive material, 2 parts by mass of a [3-(methacryloylamino) propyl]dimethyl (3-sulfopropyl) ammonium hydroxide inner salt (product name: FOM-03010, manufactured by FUJIFILM Wako Pure Chemical Corporation) as a reactive betaine compound, 6 parts by mass of N-vinyl-2-pyrrolidone (product code: 224-01282, manufactured by FUJIFILM Wako Pure Chemical Corporation), and 10 parts by mass of pentaerythritol tetrakis(3-mercaptobutyrate) (product name: KarenzMT® PE1, manufactured by Resonac Holdings Corporation) as a thiol material were added into a 300 mL separable flask equipped with a stirring blade. Next, 7 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 3.

### Example 4

63 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 3 parts by mass of a [3-(methacryloylamino) propyl]dimethyl (3-sulfopropyl) ammonium hydroxide inner salt (product name: FOM-03010, manufactured by FUJIFILM Wako Pure Chemical Corporation) as a reactive betaine compound, 9 parts by mass of N-vinyl-2-pyrrolidone (product code: 224-01282, manufactured by FUJIFILM Wako Pure Chemical Corporation), and 10 parts by mass of pentaerythritol tetrakis(3-mercaptobutyrate) (product name: KarenzMT® PE1, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 4.

### Example 5

62 parts by mass of PEG 600 diacrylate (product name: EBECRYL 11, manufactured by Daicel-Allnex Ltd.) and 8 parts by mass of 2-hydroxy-3-acryloyloxypropyl methacrylate (product name: LIGHT ESTER G-201P, manufactured by Kyoeisha Chemical Co., Ltd.) as a radically reactive material, 4 parts by mass of a [3-(methacryloylamino) propyl]dimethyl (3-sulfopropyl) ammonium hydroxide inner salt (product name: FOM-03010, manufactured by FUJIFILM Wako Pure Chemical Corporation) as a reactive betaine compound, 15 parts by mass of N-vinyl-2-pyrrolidone (product code: 224-01282, manufactured by FUJIFILM Wako Pure Chemical Corporation), and 7 parts by mass of pentaerythritol tetrakis(3-mercaptobutyrate) (product name: KarenzMT® PE1, manufactured by Resonac Holdings Corporation) as a thiol material were added into a 300 mL separable flask equipped with a stirring blade. Next, 4 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 5.

### Example 6

63 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 3 parts by mass of a [3-(methacryloylamino) propyl]dimethyl (3-sulfopropyl) ammonium hydroxide inner salt (product name: FOM-03010, manufactured by FUJIFILM Wako Pure Chemical Corporation) as a reactive betaine compound, 9 parts by mass of N-vinyl-2-pyrrolidone (product code: 224-01282, manufactured by FUJIFILM Wako Pure Chemical Corporation), and 10 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 6.

### Example 7

65 parts by mass of PEG200 diacrylate (product name: PEG200DA, manufactured by Daicel-Allnex Ltd.) and 10 parts by mass of 1,3-diallyloxy-2-propanol (product code: D2146, manufactured by Tokyo Chemical Industry Co., Ltd.) as a radically reactive material, 2 parts by mass of a [3-(methacryloylamino) propyl]dimethyl (3-sulfopropyl) ammonium hydroxide inner salt (product name: FOM-03010, manufactured by FUJIFILM Wako Pure Chemical Corporation) as a reactive betaine compound, 6 parts by mass of N-vinyl-2-pyrrolidone (product code: 224-01282, manufactured by FUJIFILM Wako Pure Chemical Corporation), and 10 parts by mass of pentaerythritol tetrakis(3-mercaptobutyrate) (product name: KarenzMT® PE1, manufactured by Resonac Holdings Corporation) as a thiol material were added into a 300 mL separable flask equipped with a stirring blade. Next, 7 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 7.

### Example 8

63 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 3 parts by mass of a [3-(methacryloylamino) propyl]dimethyl (3-sulfopropyl) ammonium hydroxide inner salt (product name: FOM-03010, manufactured by FUJIFILM Wako Pure Chemical Corporation) as a reactive betaine compound, 9 parts by mass of N-vinyl-2-pyrrolidone (product code: 224-01282, manufactured by FUJIFILM Wako Pure Chemical Corporation), and 10 parts by mass of pentaerythritol tetrakis(3-mercaptobutyrate) (product name: KarenzMT® PE1, manufactured by Resonac Holdings Corporation) as a thiol material were added into a 300 mL separable flask equipped with a stirring blade. Next, 5 parts by mass of 2-hydroxy-4′-(2-hydroxyethoxy)-2-methylpropiophenone (product code: H1361, manufactured by Tokyo Chemical Industry Co., Ltd.) as an initiator was added thereto. The mixture was stirred at room temperature for 30 minutes to obtain 100 parts by mass of an anti-fogging composition of Example 8.

### Example 9

63 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 3 parts by mass of a [3-(methacryloylamino) propyl]dimethyl (3-sulfopropyl) ammonium hydroxide inner salt (product name: FOM-03010, manufactured by FUJIFILM Wako Pure Chemical Corporation) as a reactive betaine compound, 9 parts by mass of N-vinyl-2-pyrrolidone (product code: 224-01282, manufactured by FUJIFILM Wako Pure Chemical Corporation), and 10 parts by mass of pentaerythritol tetrakis(3-mercaptobutyrate) (product name: KarenzMT® PE1, manufactured by Resonac Holdings Corporation) as a thiol material were added into a 300 mL separable flask equipped with a stirring blade. Next, 3 parts by mass of 1-hydroxycyclohexyl phenyl ketone (product name: Omnirad 184, manufactured by Sanyo Trading Co., Ltd.) and 2 parts by mass of 2-hydroxy-4′-(2-hydroxyethoxy)-2-methylpropiophenone (product code: H1361, manufactured by Tokyo Chemical Industry Co., Ltd.) as an initiator were added thereto. The mixture was stirred at room temperature for 30 minutes to obtain 100 parts by mass of an anti-fogging composition of Example 9.

### Example 10

53 parts by mass of PEG200 diacrylate (product name: PEG200DA, manufactured by Daicel-Allnex Ltd.) and 17 parts by mass of 2-hydroxy-3-acryloyloxypropyl methacrylate (product name: LIGHT ESTER G-201P, manufactured by Kyoeisha Chemical Co., Ltd.) as a radically reactive material, 10 parts by mass of a [3-(methacryloylamino) propyl]dimethyl (3-sulfopropyl) ammonium hydroxide inner salt (product name: FOM-03010, manufactured by FUJIFILM Wako Pure Chemical Corporation) as a reactive betaine compound, 15 parts by mass of N-vinyl-2-pyrrolidone (product code: 224-01282, manufactured by FUJIFILM Wako Pure Chemical Corporation), and 3 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 2 parts by mass of 1-hydroxycyclohexyl phenyl ketone (product name: Omnirad 184, manufactured by Sanyo Trading Co., Ltd.) as an initiator was added thereto, and the mixture was stirred at room temperature for 30 minutes to obtain 100 parts by mass of an anti-fogging composition of Example 10.

### Example 11

70 parts by mass of PEG200 diacrylate (product name: PEG200DA, manufactured by Daicel-Allnex Ltd.) and 16 parts by mass of 2-hydroxy-3-acryloyloxypropyl methacrylate (product name: LIGHT ESTER G-201P, manufactured by Kyoeisha Chemical Co., Ltd.) as a radically reactive material, 0.1 parts by mass of a [3-(methacryloylamino) propyl]dimethyl (3-sulfopropyl) ammonium hydroxide inner salt (product name: FOM-03010, manufactured by Tokyo Chemical Industry Co., Ltd.) as a reactive betaine compound, 6.9 parts by mass of N-vinyl-2-pyrrolidone (product code: 224-01282, manufactured by FUJIFILM Wako Pure Chemical Corporation), and 2 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 11.

### Example 12

87 parts by mass of PEG 200 diacrylate (product name: PEG200DA, manufactured by Daicel-Allnex Ltd.) as a radically reactive material, 0.5 parts by mass of a [3-(methacryloylamino) propyl]dimethyl (3-sulfopropyl) ammonium hydroxide inner salt (product name: FOM-03010, manufactured by Tokyo Chemical Industry Co., Ltd.) as a reactive betaine compound, 1 part by mass of N-vinyl-2-pyrrolidone (product code: 224-01282, manufactured by FUJIFILM Wako Pure Chemical Corporation), and 6.5 parts by mass of pentaerythritol tetrakis(3-mercaptobutyrate) (product name: KarenzMT® PE1, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 12.

### Example 13

63 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 3 parts by mass of 2-methacryloyloxyethylphosphorylchloride (product name: M2005, manufactured by Tokyo Chemical Industry Co., Ltd.) as a reactive betaine compound, 9 parts by mass of N-vinyl-2-pyrrolidone (product code: 224-01282, manufactured by FUJIFILM Wako Pure Chemical Corporation), and 10 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 13.

### Example 14

63 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 3 parts by mass of 3-[[2-(methacryloyloxy)ethyl]-dimethylammonio]propane-1-sulfonate (product name: M1971, manufactured by Tokyo Chemical Industry Co., Ltd.) as a reactive betaine compound, 9 parts by mass of N-vinyl-2-pyrrolidone (product code: 224-01282, manufactured by FUJIFILM Wako Pure Chemical Corporation), and 10 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 14.

### Example 15

63 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 3 parts by mass of 2-[[2 (methacryloyloxy)ethyl]-dimethylammonio]acetate (product name: M3185, manufactured by Tokyo Chemical Industry Co., Ltd.) as a reactive betaine compound, 9 parts by mass of N-vinyl-2-pyrrolidone (product code: 224-01282, manufactured by FUJIFILM Wako Pure Chemical Corporation), and 10 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 15.

### Example 16

63 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 3 parts by mass of 3-[(3-acrylamidopropyl)-dimethylammonio]propanoate (product name: A3279, manufactured by Tokyo Chemical Industry Co., Ltd.) as a reactive betaine compound, 9 parts by mass of N-vinyl-2-pyrrolidone (product code: 224-01282, manufactured by FUJIFILM Wako Pure Chemical Corporation), and 10 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 16.

### Example 17

63 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 3 parts by mass of 3-[[2-(acryloyloxy)ethyl]-dimethylammonio]propane-1-sulfonate (product name: A3367, manufactured by Tokyo Chemical Industry Co., Ltd.) as a reactive betaine compound, 9 parts by mass of N-vinyl-2-pyrrolidone (product code: 224-01282, manufactured by FUJIFILM Wako Pure Chemical Corporation), and 10 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 17.

### Example 18

63 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 3 parts by mass of 3-[(3-acrylamidopropyl)-dimethylammonio]propane-1-sulfonate (product name: A3361, manufactured by Tokyo Chemical Industry Co., Ltd.) as a reactive betaine compound, 9 parts by mass of N-vinyl-2-pyrrolidone (product code: 224-01282, manufactured by FUJIFILM Wako Pure Chemical Corporation), and 10 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Example 18.

### Comparative Example 1

90 parts by mass of PEG200 diacrylate (product name: PEG200DA, manufactured by Daicel-Allnex Ltd.) as a radically reactive material was added into a 300 mL separable flask equipped with a stirring blade. Next, 10 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Comparative Example 1. That is, the anti-fogging composition of Comparative Example 1 is an anti-fogging composition not containing a reactive betaine compound and N-vinyl-2-pyrrolidone.

### Comparative Example 2

64 parts by mass of PEG200 diacrylate (product name: PEG200DA, manufactured by Daicel-Allnex Ltd.) and 17 parts by mass of 2-hydroxy-3-acryloyloxypropyl methacrylate (product name: LIGHT ESTER G-201P, manufactured by Kyoeisha Chemical Co., Ltd.) as a radically reactive material, 10 parts by mass of a [3-(methacryloylamino) propyl]dimethyl (3-sulfopropyl) ammonium hydroxide inner salt (product name: FOM-03010, manufactured by Tokyo Chemical Industry Co., Ltd.) as a reactive betaine compound, and 3 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 6 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Comparative Example 2. That is, the anti-fogging composition of Comparative Example 2 is an anti-fogging composition not containing N-vinyl-2-pyrrolidone.

### Comparative Example 3

63 parts by mass of PEG200 diacrylate (product name: PEG200DA, manufactured by Daicel-Allnex Ltd.) and 20 parts by mass of 2-hydroxy-3-acryloyloxypropyl methacrylate (product name: LIGHT ESTER G-201P, manufactured by Kyoeisha Chemical Co., Ltd.) as a radically reactive material, 9 parts by mass of N-vinyl-2-pyrrolidone (product code: 224-01282, manufactured by FUJIFILM Wako Pure Chemical Corporation), and 3 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Comparative Example 3. That is, the anti-fogging composition of Comparative Example 3 is an anti-fogging composition not containing a reactive betaine compound.

### Comparative Example 4

53 parts by mass of PEG200 diacrylate (product name: PEG200DA, manufactured by Daicel-Allnex Ltd.) and 20 parts by mass of 2-hydroxy-3-acryloyloxypropyl methacrylate (product name: LIGHT ESTER G-201P, manufactured by Kyoeisha Chemical Co., Ltd.) as a radically reactive material, 10 parts by mass of a non-reactive betaine compound (CAS registration number: 107-43-7, manufactured by FUJIFILM Wako Pure Chemical Corporation), 9 parts by mass of N-vinyl-2-pyrrolidone (product code: 224-01282, manufactured by FUJIFILM Wako Pure Chemical Corporation), and 3 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Comparative Example 4. That is, the anti-fogging composition of Comparative Example 4 is an anti-fogging composition including a radically reactive material, a non-reactive betaine compound, N-vinyl-2-pyrrolidone, and a thiol material.

### Comparative Example 5

57 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 12 parts by mass of 3-[(3-acrylamidopropyl)-dimethylammonio]propanoate (product name: A3279, manufactured by Tokyo Chemical Industry Co., Ltd.) as a reactive betaine compound, 13 parts by mass of N-vinyl-2-pyrrolidone (product code: 224-01282, manufactured by FUJIFILM Wako Pure Chemical Corporation), and 4 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 4 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Comparative Example 5. That is, the anti-fogging composition of Comparative Example 5 is an anti-fogging composition having a content of the reactive betaine compound with respect to the anti-fogging composition of more than 10%.

### Comparative Example 6

76.92 parts by mass of PEG200 diacrylate (product name: PEG200DA, manufactured by Daicel-Allnex Ltd.) and 12 parts by mass of 2-hydroxy-3-acryloyloxypropyl methacrylate (product name: LIGHT ESTER G-201P, manufactured by Kyoeisha Chemical Co., Ltd.) as a radically reactive material, 0.08 parts by mass of 3-[(3-acrylamidopropyl)-dimethylammonio]propanoate (product name: A3279, manufactured by Tokyo Chemical Industry Co., Ltd.) as a reactive betaine compound, 3 parts by mass of N-vinyl-2-pyrrolidone (product code: 224-01282, manufactured by FUJIFILM Wako Pure Chemical Corporation), and 4 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 4 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Comparative Example 6. That is, the anti-fogging composition of Comparative Example 6 is an anti-fogging composition having a content of a reactive betaine compound with respect to the anti-fogging composition of less than 0.1%.

### Comparative Example 7

60 parts by mass of PEG200 diacrylate (product name: PEG200DA, manufactured by Daicel-Allnex Ltd.) and 10 parts by mass of 2-hydroxy-3-acryloyloxypropyl methacrylate (product name: LIGHT ESTER G-201P, manufactured by Kyoeisha Chemical Co., Ltd.) as a radically reactive material, 3 parts by mass of 3-[(3-acrylamidopropyl)-dimethylammonio]propanoate (product name: A3279, manufactured by Tokyo Chemical Industry Co., Ltd.) as a reactive betaine compound, 17 parts by mass of N-vinyl-2-pyrrolidone (product code: 224-01282, manufactured by FUJIFILM Wako Pure Chemical Corporation), and 5 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Comparative Example 7. That is, the anti-fogging composition of Comparative Example 7 is an anti-fogging composition having a content of N-vinyl-2-pyrrolidone with respect to the anti-fogging composition of more than 15%.

### Comparative Example 8

76.2 parts by mass of PEG200 diacrylate (product name: PEG200DA, manufactured by Daicel-Allnex Ltd.) and 7 parts by mass of 2-hydroxy-3-acryloyloxypropyl methacrylate (product name: LIGHT ESTER G-201P, manufactured by Kyoeisha Chemical Co., Ltd.) as a radically reactive material, 6 parts by mass of 3-[(3-acrylamidopropyl)-dimethylammonio]propanoate (product name: A3279, manufactured by Tokyo Chemical Industry Co., Ltd.) as a reactive betaine compound, 0.8 parts by mass of N-vinyl-2-pyrrolidone (product code: 224-01282, manufactured by FUJIFILM Wako Pure Chemical Corporation), and 5 parts by mass of trimethylolpropane tris(3-mercaptobutyrate) (product name: KarenzMT® TPMB, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Comparative Example 8. That is, the anti-fogging composition of Comparative Example 8 is an anti-fogging composition having a content of N-vinyl-2-pyrrolidone with respect to the anti-fogging composition of less than 1%.

### Comparative Example 9

69 parts by mass of PEG600 diacrylate (product name: EBECRYL 11, manufactured by Daicel-Allnex Ltd.) as a radically reactive material, 6 parts by mass of a [3-(methacryloylamino) propyl]dimethyl (3-sulfopropyl) ammonium hydroxide inner salt (product name: FOM-03010, manufactured by FUJIFILM Wako Pure Chemical Corporation) as a reactive betaine compound, 10 parts by mass of N-vinyl-2-pyrrolidone (product code: 224-01282, manufactured by FUJIFILM Wako Pure Chemical Corporation), and 10 parts by mass of pentaerythritol tetrakis(3-mercaptobutyrate) (product name: KarenzMT® PE1, manufactured by Resonac Holdings Corporation) as a thiol material were added into a 300 mL separable flask equipped with a stirring blade. Next, 5 parts by mass of 1-hydroxycyclohexyl phenyl ketone (product name: Omnirad 184, manufactured by Sanyo Trading Co., Ltd.) as an initiator was added thereto. The mixture was stirred at room temperature for 30 minutes to obtain 100 parts by mass of an anti-fogging composition of Comparative Example 9.

### (Evaluation of Elution Properties)

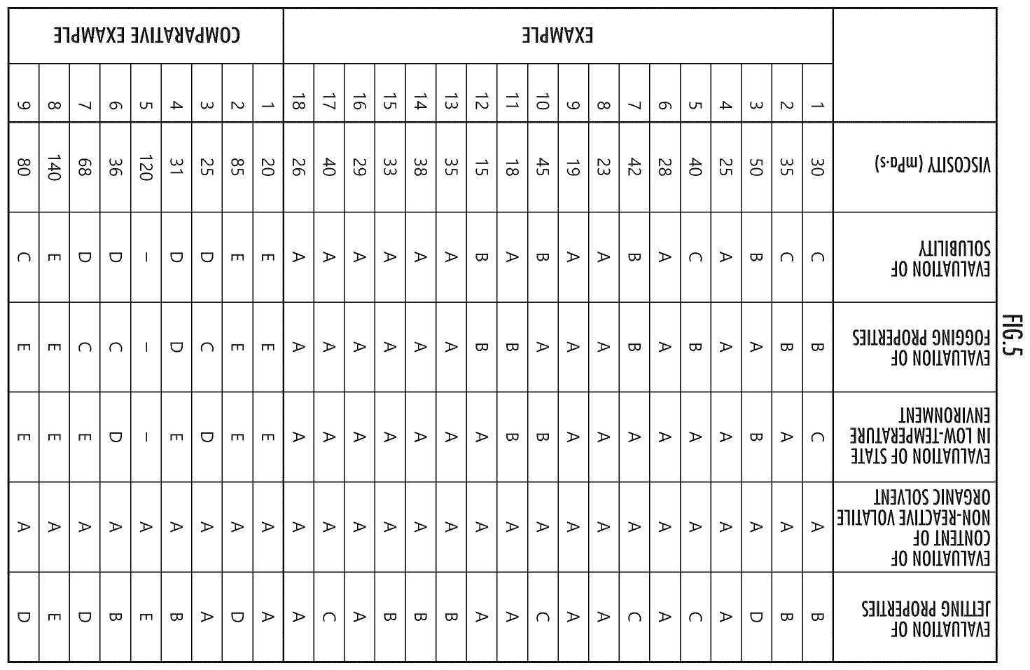

Each of test pieces obtained by curing the anti-fogging compositions of Examples 1 to 18 or the anti-fogging compositions of Comparative Examples 1 to 9 on the surface was placed on a hot plate heated to 90° C., and 20 μL of pure water heated to 50° C. was added dropwise to the test piece. Thereafter, the dropping traces visible after the evaporation of the pure water were visually confirmed to evaluate the elution properties on a 5-level scale from A to E. The evaluation was made as follows: A in a case where the trace of the eluted component was not visible; B in a case where a part of the trace of the eluted component was visible; C in a case where the trace of the eluted component was faintly spread; D in a case where the trace of the eluted component was clearly visible; and E in a case where light was not transmitted due to the eluted component. FIG. 5 summarizes the evaluation results of the elution properties of Examples 1 to 18 and Comparative Examples 1 to 9.

### (Evaluation of Anti-Fogging Properties)

Each of the test pieces in which the anti-fogging compositions of Examples 1 to 18 or the anti-fogging compositions of Comparative Examples 1 to 9 were cured on the surface was immersed in warm water at 40° C. for 240 hours. Thereafter, the test piece was dried at room temperature, the breath was blown onto the test piece at normal temperature, and the surface area of the test piece in which fogging occurred was visually confirmed to evaluate the anti-fogging properties on a 5-level scale from A to E. The evaluation was made as follows: A in a case where no fogging occurred in the test piece; B in a case where about 10% of the surface area of the test piece was fogging; C in a case where about 50% of the surface area of the test piece was fogging; D in a case where about 80% of the surface area of the test piece was fogging; and E in a case where the entire surface area of the test piece was fogging. FIG. 5 summarizes the evaluation results of the anti-fogging properties of Examples 1 to 18 and Comparative Examples 1 to 9.

### (Evaluation of State in Low-Temperature Environment)

Each of the test pieces in which the anti-fogging compositions of Examples 1 to 18 or the anti-fogging compositions of Comparative Examples 1 to 9 were cured on the surface was left in a freezer at −40° C. for 240 hours. Thereafter, the temperature was returned to room temperature and the state of the cured film was visually confirmed to evaluate the state under a low-temperature environment in 5-level scale from A to E. The evaluation was made as follows: A in a case where there was no break or crack in the cured film; B in a case where the cured film was not broken but a slight crack was found; C in a case where the cured film was not broken but a crack was found; D in a case where a break and a crack are found in a part of the cured film; and E in a case where a large break was found in the cured film. FIG. 5 summarizes the evaluation results of the states of Examples 1 to 18 and Comparative Examples 1 to 9 in a low-temperature environment.

### (Content Evaluation of Non-Reactive Volatile Organic Solvent)

Each of the anti-fogging compositions of Examples 1 to 18 or the anti-fogging compositions of Comparative Examples 1 to 9 was subjected to gas chromatography analysis at 200° C., and a total value of the components detected in a structure not including a vinyl group or an acryloyl group was determined. The evaluation was made as follows: A in a case where the total value was less than 1% by mass; B in a case where the total value was 1% by mass or more and less than 10% by mass; C in a case where the total value was 10% by mass or more and less than 30% by mass; D in a case where the total value was 30% by mass or more and less than 50% by mass; and E in a case where the total value was 50% by mass or more. FIG. 5 summarizes the evaluation results of the content of the non-reactive volatile organic solvent of Examples 1 to 18 and Comparative Examples 1 to 9.

### (Evaluation of Jetting Properties)

The viscosity of each of the anti-fogging compositions of Examples 1 to 18 or the anti-fogging compositions of Comparative Examples 1 to 9 was measured and evaluated. The viscosity was measured in accordance with JIS K2283 using an E-type viscometer (product name: TVE-22L, manufactured by Toki Sangyo Co., Ltd.). The evaluation was made as follows: A in a case where the viscosity was 3 mPa·s or more and less than 30 mPa·s; B in a case where the viscosity was 30 mPa·s or more and less than 40 mPa·s; C in a case where the viscosity was 40 mPa·s or more and less than 60 mPa·s; D in a case where the viscosity was 60 mPa·s or more and less than 80 mPa·s; and E in a case where the viscosity was 80 mPa·s or more. FIG. 5 summarizes the evaluation results of the jetting properties of Examples 1 to 18 and Comparative Examples 1 to 9.

As is clear from FIG. 5, according to Examples 1 to 18 which are the anti-fogging compositions including a radically reactive material, a reactive betaine compound, and N-vinyl-2-pyrrolidone, it is apparent that excellent elution properties and anti-fogging properties can be secured, and the occurrence of cracks in the cured film in a low-temperature environment can be suppressed. That is, a cured film having excellent anti-fogging properties and durability can be formed. Furthermore, in the present specification, the “excellent elution properties” mean that the components contained in the anti-fogging composition are difficult to be eluted.

From the results of Examples 2 to 18, it is apparent that in a case where the thiol material was contained, in the evaluation of the state in a low-temperature environment, there was no crack in the cured film, or even in a case where there was a crack, the crack was slight, and thus, the occurrence of cracks in a low-temperature environment could be further suppressed.

In contrast, according to Comparative Example 1 which is the anti-fogging composition consisting of a radically reactive material and an initiator, in the evaluation of the elution properties, light is not transmitted due to the eluted components, and thus, sufficient elution performance is not secured. In addition, in the evaluation of the anti-fogging properties, the entire surface area of the test piece was fogged, and thus, sufficient anti-fogging properties were not secured. Furthermore, in the evaluation of the state in a low-temperature environment, it is apparent that the cured film has large breaks, and thus, sufficient durability is not secured in a low-temperature environment.

In the anti-fogging composition of the presently disclosed subject matter, and the translucent member and the optical unit using the anti-fogging composition, excellent anti-fogging properties and durability can be secured.

### REFERENCE SIGNS LIST

10: anti-fogging composition
11: cured film
20: translucent member
30: housing
40: optical instrument
50: optical unit

What is claimed is:

1. An active energy ray-curable anti-fogging composition comprising:
a radically reactive material including a hydrophilic group;
a reactive betaine compound; and
N-vinyl-2-pyrrolidone,
wherein the anti-fogging composition has a viscosity of 3 mPa·s to 70 mPa·s.

2. The anti-fogging composition according to claim 1,
wherein a content of the radically reactive material is 70% to 90%,
a content of the reactive betaine compound is 0.1% to 10%,
a content of N-vinyl-2-pyrrolidone is 1% to 15%, and
a total content of the radically reactive material, the reactive betaine compound, and N-vinyl-2-pyrrolidone is 92% to 100%.

3. The anti-fogging composition according to claim 1,
wherein the anti-fogging composition includes a thiol material and has a content of the thiol material of 2% to 10%, and
a total content of the radically reactive material, the reactive betaine compound, N-vinyl-2-pyrrolidone, and the thiol material is 92% to 100%.

4. A translucent member having at least a part of a surface coated with a cured film obtained by curing the anti-fogging composition according to claim 1.

5. An optical unit comprising:
the translucent member according to claim 4;
a housing; and
an optical instrument disposed in an inner space defined by the translucent member and the housing.

6. The optical unit according to claim 5,
wherein the optical unit is a headlight unit for a vehicle, having a light emitting device as the optical instrument.

7. A method for producing a translucent member having a cured film, the method comprising:
a step of curing the anti-fogging composition according to claim 1 using active energy to form the cured film on an inner surface of the translucent member.

8. A method for producing an optical unit including a translucent member having a cured film, a housing, and an optical instrument disposed in an inner space defined by the translucent member and the housing, the method comprising:
a step of curing the anti-fogging composition according to claim 1 using active energy to form the cured film on an inner surface of the translucent member.
